(19) United States
(12) Patent Application Publication
(10) Pub. No.: US 2019/0023576 A1
(43) Pub. Date: Jan. 24, 2019

(54) COMPOSITE MATERIAL CONTAINING ARTIFICIAL GRAPHITE, GRAPHITE SHEET AND MANUFACTURING METHOD OF MANUFACTURING THE SAME

(71) Applicant: MORTECH CORPORATION, Taoyuan City (TW)

(72) Inventors: Der-Jen SUN, Taoyuan City (TW); Chi-Sheng CHEN, Taoyuan City (TW); Yen-Huey HSU, Taoyuan City (TW)

(73) Assignee: MORTECH CORPORATION, Taoyuan City (TW)

(21) Appl. No.: 16/040,378

(22) Filed: Jul. 19, 2018

(30) Foreign Application Priority Data
Jul. 21, 2017 (TW) 106124657

(51) Int. Cl. C01B 32/205; C08K 3/04; C08L 79/08

(52) U.S. Cl. CPC C01B 32/205; C08K 3/04; C08L 79/08; C01P 2006/32; C08L 2203/20; C01P 2004/64; C08L 2203/16

(57) ABSTRACT

A method of manufacturing composite material containing artificial graphite is disclosed. An artificial graphite powder and a first solvent are mixed together to obtain a graphite dispersion solution, and a particle size of the graphite powder is less than 50 μm. The graphite dispersion solution and a polyamic acid solution are mixed together to obtain a liquid mixture. The liquid mixture is heated to obtain a polyamic acid film containing artificial graphite powder. The imidization of the polyamic acid film is performed to obtain the composite material containing artificial graphite. A method of manufacturing a graphite sheet by using the composite material containing artificial graphite as raw material is disclosed.

### CROSS-REFERENCE TO RELATED APPLICATIONS

This non-provisional application claims priority under 35 U.S.C. § 119(a) on Patent Application No(s). 106124657 filed in Taiwan R.O.C. on Jul. 21, 2017, the entire contents of which are hereby incorporated by reference.

### TECHNICAL FIELD

The present disclosure provides a method of manufacturing a composite material containing artificial graphite and a graphite sheet, more particular to a composite material containing artificial graphite powder and a graphite sheet manufactured by using the aforementioned composite material.

### BACKGROUND

Static electricity is ubiquitous in nature, and the generation of the static electricity mainly comes from friction between insulating objects. Electrostatic discharge (ESD) usually occurs when the surfaces of two insulating objects are rubbed. The electrostatic discharge may damage sensitive electronic components, change magnetic media and ignite flammable atmosphere. The cost for reducing the damage of electrostatic discharge in the electronics industry is estimated to be more than US$40 billion every year.

Due to the popularization of various electronic products and the improvement of their performance, electromagnetic energy in the electronic products may increase, and the limitation on reduction of electromagnetic interference (EMI) is also increasingly strict.

In order to reduce the risk of electrostatic discharge and the influence of electromagnetic interference, a conventional method is to use a composite material containing natural graphite powder as an element in an electronic component. However, since the natural graphite has loosely arranged lattice structure, numerous lattice defects and many pores easily absorbing water, the thermal conductivity of the natural graphite sheet along an extension direction of a carbon layer (X-Y plane) is only from 200 W/m·K to 500 W/m·K, and the electric conductivity of the natural graphite sheet along the direction extension of the carbon layer is only 1×10⁵ S/m to 3.5×10⁵ S/m. In addition, the structural strength of the natural graphite sheet is insufficient, such that the natural graphite sheet easily breaks or peels off, which makes the composite material easily wear out.

In addition to the aforementioned problems, the components for anti-static or electromagnetic wave shielding is usually manufactured by electroplating metal film, conductive paint and so on, and the surfaces of the components may be polluted due to non-sloughing of the metal film or conductive paint.

Therefore, the improvement of the mechanical properties of composite material to increase its reliability and the reduction of pollution caused by non-sloughing of the coating on the composite material have become some issues needed to be solved urgently.

The natural graphite powder is obtained from graphite ore. Graphite mining of the graphite ore is a highly polluting industry since a large amount of graphite dust is generated during the graphite mining process. The graphite dust existed in air, soil or water may affect the growth of plants and the health of animals. However, as a main material for manufacturing heat dissipation components, electrostatic discharge protection components and electromagnetic shielding components in the electronic products, the demand of graphite powder has increased in recent years, and the impact of graphite mining on the environment has become more serious.

With the attention to environmental protection and corporate social responsibility, many companies, such as Apple, Samsung, and LG, have started to use environment friendly materials to produce their electronic products. Further, Apple has built a closed-loop supply chain (green supply chain) by using the components in electronic wastes as the aforementioned materials to produce the electronic products. Therefore, the development of a recyclable and reusable composite material for manufacturing heat dissipating components, electrostatic discharge protection components and electromagnetic shielding components is a mainstream of research in recent years.

### SUMMARY

The present disclosure provides a method of manufacturing a composite material containing artificial graphite powder; particularly, the artificial graphite powder has a particle size smaller than 50 micrometers (μm). The composite material containing artificial graphite powder is free from low reliability and non-sloughing. Furthermore, the composite material containing artificial graphite powder meets the requirement of green supply chain management. The composite material containing artificial graphite powder is able to be recycled to manufacture new artificial graphite powder. Also, a graphite sheet manufactured from the composite material is able to be recycled to manufacture new artificial graphite powder.

According to one aspect the disclosure, a method of manufacturing a composite material containing artificial graphite includes the steps of: mixing an artificial graphite powder and a first solvent together to obtain a graphite dispersion solution, wherein a particle size of the graphite powder is less than 50 μm; mixing the graphite dispersion solution and a polyamic acid solution together to obtain a liquid mixture; heating the liquid mixture to obtain a polyamic acid film containing the artificial graphite powder; and performing imidization of the polyamic acid film containing the artificial graphite powder to obtain the composite material containing artificial graphite.

According to another aspect of the disclosure, a composite material containing artificial graphite includes a polyimide base material and an artificial graphite powder. The artificial graphite powder is distributed in the polyimide base material, and a particle size of the graphite powder is less than 50 μm.

According to still another aspect of the disclosure, a method of manufacturing a graphite sheet includes the steps of: providing a composite material containing artificial graphite manufactured by the aforementioned method; and heating the composite material containing artificial graphite to obtain the graphite sheet.

According to yet still another aspect of the disclosure, a method of manufacturing a composite material containing artificial graphite includes the steps of: mixing an artificial graphite powder and a first solvent together to obtain a graphite dispersion solution, wherein the artificial graphite powder is obtained by graphitizing a substandard polyimide film; mixing the graphite dispersion solution and a polyamic acid solution together to obtain a liquid mixture; heating the liquid mixture to obtain a polyamic acid film containing the artificial graphite powder; and performing imidization of the polyamic acid film containing the artificial graphite powder to obtain the composite material containing artificial graphite.

According to the disclosure, the artificial graphite powder is mixed with the polyamic acid solution, and then the polyamic acid is imidized to obtain the polyimide film containing evenly distributed artificial graphite powder. The polyimide film containing artificial graphite powder is the composite material containing artificial graphite. The artificial graphite powder in the composite material is favorable for improving mechanical properties as well as preventing non-sloughing problems of a conductive layer in the conventional composite material.

The recycled composite material containing artificial graphite is able to be reprocessed to manufacture a graphite sheet by the method of the disclosure, and the graphite sheet is able to be smashed to obtain the artificial graphite powder for manufacturing new composite material. In other words, the artificial graphite powder is obtained by reprocessing the composite material containing artificial graphite taken from a discarded electronic device, and the artificial graphite powder is used to manufacture a new composite material which is applicable to new electronic devices. Therefore, the composite material containing artificial graphite, the graphite sheet and the method of manufacturing the same meet the requirement of green supply chain management.

### BRIEF DESCRIPTION OF THE DRAWINGS

The present disclosure will become more understood from the detailed description given hereinbelow and the accompanying drawings which are given by way of illustration only and thus are not limitative of the present disclosure and wherein:

FIG. 1 is a flow chart showing method of manufacturing composite material containing artificial graphite, according to one embodiment of the disclosure;

FIG. 2 is a flow chart showing method of manufacturing graphite sheet which is made from composite material containing artificial graphite, according to one embodiment of the disclosure;

FIG. 3 is a line chart showing a relation between mass of graphite powder and Young's modulus, according to a first embodiment through a sixth embodiment of the disclosure and a first comparative embodiment through a fifth comparative embodiment; and

FIG. 4 is a line chart showing tensile strength of polyimide film according to a seventh embodiment through an eleventh embodiment of the disclosure and a sixth comparative embodiment through a tenth comparative embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

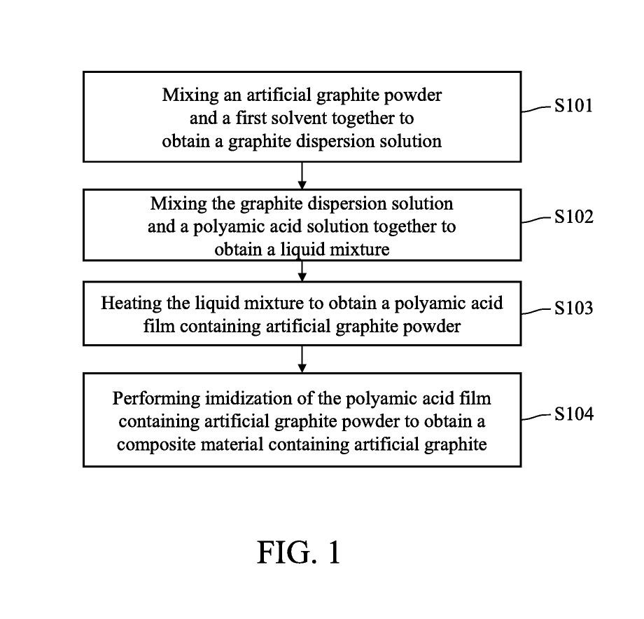

FIG. 1 is a flow chart showing method of manufacturing composite material containing artificial graphite, according to one embodiment of the disclosure. In one embodiment, a method of manufacturing a composite material containing artificial graphite includes steps S101 through S104.

In the step S101, an artificial graphite powder and a first solvent are mixed together to obtain a graphite dispersion solution, and the particle size of the artificial graphite powder is less than 50 μm.

In detail, a bulk of artificial graphite is smashed and ground to obtain the artificial graphite powder. Next, the artificial graphite powder is filtered, such that the artificial graphite powder having a particle size greater than 50 μm is removed. In one embodiment, the artificial graphite powder is mixed with the first solvent by ball milling dispersion to obtain the graphite dispersion solution.

The graphite dispersion solution can be filtered to remove larger graphite powder. After the graphite dispersion solution is filtered, the mass fraction of the artificial graphite powder in the graphite dispersion solution is less than or equal to 10 wt %. Therefore, it is favorable for preventing clusters of larger artificial graphite powder, thereby maintaining high efficiency of filtration. The filtered graphite dispersion solution is ball-milled to ensure even distribution of the artificial graphite powder in the graphite dispersion solution. The first solvent, preferably, is polar solvent, but the present disclosure is not limited thereto. In some other embodiments, the first solvent is non-polar solvent.

Due to a special bonding structure between the carbon atoms of the artificial graphite, high mechanical strength, high electric conductivity and high thermal conductivity are observed along a planar structure of the carbon atoms arranged in hexagonal ring arrays in the sp²-hybridized state. According to the disclosure, the artificial graphite includes nearly perfect planar layered structure so as to enjoy higher mechanical strength, higher electric conductivity and higher thermal conductivity than natural graphite. Based on the crystalline perfection, the thermal conductivity of a graphite sheet along an extension direction of a carbon layer (X-Y plane) is greater than 700 W/m·K, preferably greater than 1000 W/m·K, more preferably greater than 1400 W/m·K, and much more preferably greater than 1700 W/m·K. Similarly, the electric conductivity of the graphite sheet along the extension direction of the carbon layer is greater than 9×10⁵ S/m, preferably greater than 1.3×10⁶ S/m, more preferably greater than 1.7×10⁶ S/m, and much more preferably greater than 2×10⁶ S/m.

In one embodiment, the artificial graphite is obtained by carbonizing and graphitizing a polyimide film containing natural graphite. In another embodiment, the artificial graphite is obtained by graphitizing a substandard polyimide film. According to still another embodiment, the artificial graphite is obtained by smashing a heat sink in a discarded electronic device (electronic waste). The artificial graphite powder is obtained by smashing the graphitized polyimide film or the polyimide film heat sink.

In one embodiment, the substandard polyimide film is a polyimide film including cracks, defects, wrinkles, creases, streaks or scratches, such that it is unavailable to be as an element in an electronic device. In another embodiment, the substandard polyimide film is a film scrap from a standard polyimide film after a film cutting process. In still another embodiment, the substandard polyimide film is an unusable polyimide film in a discarded electronic device.

In the ball milling dispersion, the artificial graphite powder in the solvent is ball-milled by, for example, multiple zirconia beads for 4 cycles. Each cycle of ball milling takes 50 minutes, and 10 minutes pause is between two cycles. The zirconia beads grinds and refines the artificial graphite powder. After the ball milling dispersion is finished, the zirconia beads are removed to obtain the aforementioned graphite dispersion solution.

Additional solvent is added to dilute the graphite dispersion solution, such that the mass fraction of the artificial graphite powder in the diluted graphite dispersion solution is proper for preventing clusters of the artificial graphite powder, such that a polyamic acid solution and the diluted graphite dispersion solution are evenly mixed together more easily, thereby enjoying an easier formation of a polyamic acid film and preventing uneven distribution of the artificial graphite powder in the polyamic acid film. During the ball milling dispersion and the dilution of the graphite dispersion solution, the polar solvent is preferable, but non-polar solvent is also acceptable in some embodiments.

In one embodiment, the mass fraction of the artificial graphite powder in the diluted graphite dispersion solution is less than or equal to 10 wt %. In some other embodiments, the mass fraction of the artificial graphite powder in the diluted graphite dispersion solution is 7 wt %, 5.5 wt %, 4.5 wt % or 2.5 wt %. When the mass fraction of the artificial graphite powder in the diluted graphite dispersion solution is no more than 10 wt %, the higher dispersion of the artificial graphite powder is favorable for preventing clusters of the artificial graphite powder. Therefore, when the diluted graphite dispersion solution is mixed with other solvents, the artificial graphite powder is evenly distributed in the solution more quickly.

When the first solvent is polar solvent, the first solvent is selected from the group consisting of N,N-dimethyl formamide (DMF), dimethylacetamide (DMAc), dimethyl sulfoxide (DMSO), N-methyl-2-pyrrolidone (NMP), gamma-Butyrolactone (GBL) and combination thereof. It is worth noting that the first solvent in the present disclosure is not limited by the above.

In the step S102, the graphite dispersion solution and a polyamic acid (PAA) solution is mixed together to obtain a liquid mixture.

In one embodiment, in the step S102, the graphite dispersion solution, a second solvent, a diamine and a dianhydride are mixed together to obtain the liquid mixture. The mole ratio of the diamine to the dianhydride in the liquid mixture is from 0.98:1 to 1.05:1.

In detail, the second solvent is added into the diluted graphite dispersion solution. When the second solvent is polar solvent, the second solvent is selected from the group consisting of N,N-dimethyl formamide (DMF), dimethylacetamide (DMAc), dimethyl sulfoxide (DMSO), N-methyl-2-pyrrolidone (NMP), gamma-butyrolactone (GBL) and combination thereof. It is worth noting that the second solvent in the present disclosure is not limited by the above. Preferably, the second solvent is the same as the solvent of the graphite dispersion solution. When the second solvent and the graphite dispersion solution are mixed and stirred, the diamine is added so as to be dissolved in the graphite dispersion solution and evenly mixed with the artificial graphite powder. The dianhydride is then added into the graphite dispersion solution containing the diamine, such that the dianhydride reacts with the diamine to generate the polyamic acid, thereby obtaining the liquid mixture.

In some other embodiments, the second solvent, the diamine and the dianhydride are mixed together firstly to obtain the polyamic acid solution. Then, the graphite dispersion solution is added into the polyamic acid solution to obtain the liquid mixture.

In some embodiments, there is no chemical reaction between the solvent and other components, such as the artificial graphite powder, the diamine, the dianhydride, the polyamic acid and a catalyst, in the liquid mixture. However, the artificial graphite powder is dissolvable in the solvent, and the solvent is mixable with the diamine, the dianhydride and the polyamic acid. The solvent is volatile and removable from the liquid mixture by heat.

The diamine is selected from the group consisting of 1,4-diamino benzene, 1,3-diamino benzene, 4,4′-oxydianiline (ODA), 3,4′-oxydianiline, 4,4′-methylene dianiline, N,N-diphenylethylenediamine, diaminobenzophenone, diaminodiphenyl sulfone, 1,5-naphthalene diamine, 4,4′-diaminodiphenyl sulfide, 1,3-bis(3-aminophenoxy)benzene, 1,4-bis(4-aminophenoxy)benzene, 1,3-bis(4-aminophenoxy)benzene, 2,2′-bis[4-(4-aminophenoxy)phenyl]propane, 4,4′-bis-(4-aminophenoxy)biphenyl, 4,4′-bis-(3-aminophenoxy)biphenyl, 1,3-Bis(3-aminopropyl)-1,1′,3,3′-tetramethyldisiloxane, 1,3-bis(3-aminopropyl)-1,1′,3,3′-tetraphenyldisiloxane, 1,3-bis(aminopropyl)-dimethyldiphenyldisiloxane, and combination thereof.

The dianhydride is selected from the group consisting of 1,2,4,5-benzenetetracarboxylic dianhydride (PMDA), 3,3 ‘,4,4’-biphenyltetracarboxylic dianhydride, 4,4′-oxydiphthalic anhydride, benzophenonetetracarboxylicdianhydride, 3,3′,4,4′-diphenyl sulfonetetracarboxylic dianhydride, 1,2,5,6-naphthalenetetracarboxylic dianhydride, naphthalenetetracarboxylic dianhydride, bis(3,4-dicarboxyphenyl)dimethylsilane dianhydride, 1,3-bis(4′-phthalic anhydride)-tetramethyldisiloxane, and combination thereof.

In one embodiment, when the viscosity of the liquid mixture reaches 10,000 cps to 50,000 cps (that is, 100 poise (ps) to 500 ps), adding the dianhydride and stirring the liquid mixture are stopped. Therefore, it is favorable for preventing overly high viscosity of the liquid mixture, such that the liquid mixture is easily spread on a substrate for the formation of polyamic acid film. Preferably, the viscosity of the liquid mixture is less than or equal to 20,000 cps.

In one embodiment, the mass ratio of the artificial graphite powder to a total of the diamine and the dianhydride (the mass of diamine+the mass of dianhydride) in the liquid mixture is from 0.5:100 to 50:100, but the disclosure is not limited thereto. In some other embodiments, the mass ratio of the artificial graphite powder to the total of the diamine and the dianhydride in the liquid mixture is from 0.5:100 to 15:100. In still some other embodiments, the mass ratio of the artificial graphite powder to the total of the diamine and the dianhydride in the liquid mixture is from 15:100 to 25:100. In yet some other embodiments, the mass ratio of the artificial graphite powder to the total of the diamine and the dianhydride in the liquid mixture is from 25:100 to 50:100.

In some embodiments, the liquid mixture includes a catalyst for follow-up chemical imidization of the of the polyamic acid film containing artificial graphite powder.

In the step S103, the liquid mixture is heated to obtain a polyamic acid film containing artificial graphite powder.

In detail, the liquid mixture is spread on a substrate, and the substrate containing liquid mixture is heated at a temperature of 120° C. to 200° C. The solvent in the liquid mixture is vaporized by heat so as to be removed from the liquid mixture, thereby obtaining the polyamic acid film containing artificial graphite powder. The polyamic acid film is separated from the substrate for follow-up processes. The temperature for removing the solvent can be the boiling point of the solvent. In one embodiment, the temperature for removing the solvent is from 120° C. to 200° C., but the disclosure is not limited thereto.

In the step S104, an imidization of the polyamic acid film containing artificial graphite powder is performed to obtain the composite material containing artificial graphite.

In detail, the polyamic acid film containing artificial graphite powder is heated at a temperature of 250° C. to 400° C., which is higher than the temperature for removing the solvent in the liquid mixture. The imidization of the polyamic acid film occurs when the polyamic acid film is heated. The imidization results in dehydration and imide ring closure reaction so as to obtain a polyimide film. The polyamic acid film containing evenly distributed artificial graphite powder is imidized to obtain the polyimide film containing artificial graphite powder, and the polyimide film containing artificial graphite powder is the composite material containing artificial graphite. In one embodiment, the mass fraction of the artificial graphite powder in the composite material containing artificial graphite is from 0.5 wt % to 40 wt %. In some other embodiments, the mass fraction of the artificial graphite powder in the composite material containing artificial graphite is from 0.5 wt % to 36 wt %.

Since high thermal conductivity of the artificial graphite along a planar structure of the carbon atoms arranged in hexagonal ring arrays in the sp²-hybridized state, heat in the polyamic acid film containing artificial graphite powder quickly transfers from the surface of the polyamic acid film to the inside of the polyamic acid film. Therefore, the polyamic acid film containing artificial graphite powder is evenly heated so as to reduce the imidization time. Moreover, the polyimide film obtained by the imidization of polyamic acid film containing artificial graphite powder includes continuously arranged and ordered polyimide molecules. During the manufacture of a graphite sheet by using the polyimide film as a raw material, the continuously arranged and ordered polyimide molecules are carbonized and graphitized to form a layer-by-layer structure including continuously arranged and ordered carbon atoms, such that the graphite sheet has high thermal conductivity and high electron mobility.

The higher the temperature for heating the polyamic acid film containing artificial graphite powder is, the faster the imidization of the polyamic acid film is. In some embodiments, the polyamic acid film containing artificial graphite powder is heated at a temperature of 270° C. to 450° C. In some other embodiments, the polyamic acid film containing artificial graphite powder is heated at a temperature of 270° C. to 350° C. In still some other embodiments, the polyamic acid film containing artificial graphite powder is heated at a temperature of 150° C. to 270° C. The imidization time is from 25 minutes to 35 minutes.

Moreover, in one embodiment, the polyamic acid film containing artificial graphite powder is clamped by a fixture and heated to be imidized, but the disclosure is not limited thereto. In some other embodiments, the polyamic acid film containing artificial graphite powder is uniaxially stretched and heated to be imidized.

When the liquid mixture includes a catalyst, the imidization of the polyamic acid film includes chemical imidization and thermal imidization. In chemical imidization, the polyamic acid is imidized with the catalyst to trigger dehydration and imide ring closure reaction, thereby forming polyimide. In thermal imidization, the polyamic acid is heated to trigger dehydration and imide ring closure reaction, thereby forming polyimide. The combination of chemical imidization and thermal imidization provides better quality of the polyimide film. In some embodiments, the catalyst is acetic anhydride with pyridine. In some other embodiments, the catalyst is tertiary amine such that the imidization of the polyamic acid film is able to be performed at a lower temperature.

Due to the special bonding structure between the carbon atoms of the artificial graphite, high mechanical strength is observed along the planar structure of the carbon atoms arranged in hexagonal ring arrays in the sp²-hybridized state. Thus, the artificial graphite powder evenly distributed in the composite material is taken as a reinforcement material to improve the mechanical properties of the composite material and increase the reliability of the composite material.

Compared to natural graphite, artificial graphite enjoys higher lattice perfection and longer distance of π electron transfer, such that artificial graphite has higher electron mobility than natural graphite. When the composite material contains the same mass of graphite powder, the composite material containing artificial graphite powder has smaller electric resistivity than the composite material containing natural graphite powder. The more the artificial graphite powder in the composite material is, the smaller the surface resistivity of the composite material is. Due to smaller surface resistivity, the composite material containing artificial graphite powder is applicable to anti-static and electromagnetic interference reduction.

As to anti-static, small surface resistivity of the composite material containing artificial graphite reduces electrostatic charge. Specifically, the electrons on the surface of the composite material are easily removed so as to prevent electrostatic discharge. Thus, the composite material containing artificial graphite powder is applicable to electrostatic dissipation (ESD) and ESD protection.

As to electromagnetic interference reduction, a conventional way to reduce electromagnetic interference is to coat metal film or conductive paint on the surface of the composite material; however, the metal film or the conductive paint easily peels off. According to the disclosure, the artificial graphite powder is evenly distributed in the composite material so as to prevent worse electromagnetic interference due to peeling off of the metal film or the conductive paint.

Since the composite material containing artificial graphite is able to be used as a film for anti-static, electromagnetic interference reduction or electric conduction, it is widely applicable to optoelectronic products and communication products, especially portable electronic devices.

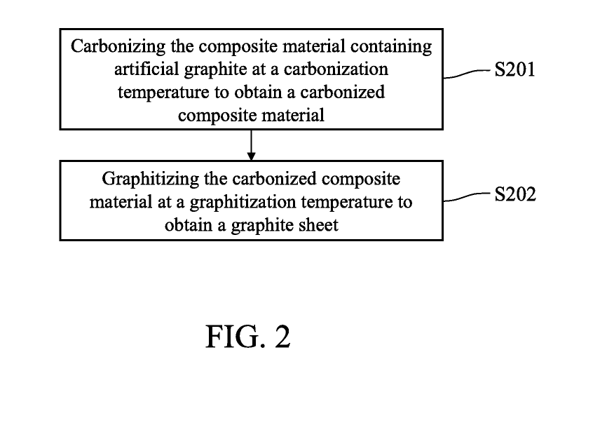

FIG. 2 is a flow chart showing method of manufacturing graphite sheet which is made from composite material containing artificial graphite, according to one embodiment of the disclosure. In one embodiment, a method of manufacturing a graphite sheet includes steps S201 and S202.

In the step S201, a composite material containing artificial graphite is carbonized at a carbonization temperature to obtain a carbonized composite material.

In detail, when placed in a low pressure environment, a nitrogen atmosphere or an inert gas atmosphere, the composite material containing artificial graphite is heated at the carbonization temperature of 800° C. to 1500° C., such that the polyimide in the composite material is carbonized, thereby obtaining the carbonized composite material. For example, the composite material containing artificial graphite is placed in a chamber having a pressure lower than 1.0 atm and heated for carbonization; alternatively, the composite material containing artificial graphite is placed in a chamber with nitrogen atmosphere and heated for carbonization.

The composite material containing artificial graphite is used as a raw material for manufacturing graphite sheet in one embodiment. The composite material containing artificial graphite is either manufactured by the aforementioned method in FIG. 1 or obtained from a component containing artificial graphite in a discarded electronic device. The component containing artificial graphite in the discarded electronic device is a heat dissipation component, an electrostatic discharge protection component or an electromagnetic shielding component. In some embodiments, the heat dissipation component, the electrostatic discharge protection component or the electromagnetic shielding component is smashed, optionally graphitized, to obtain artificial graphite powder.

The heat dissipation component is, for example, a heat sink, a finned tube, a metal plate including carbon nanotubes or a graphite sheet. The electrostatic discharge protection component is, for example, a varistor, a semiconductor diode or a polymer light emitting diode. The electromagnetic shielding component is, for example, a sleeve for electric connector or a gasket.

In one embodiment, the composite material containing artificial graphite is manufactured by using scraps of an artificial graphite sheet as raw material. The scraps are generated by cutting or stamping the artificial graphite sheet.

In the step S202, the carbonized composite material is graphitized at a graphitization temperature to obtain the graphite sheet, and the graphitization temperature is higher than the carbonization temperature.

In detail, when placed in a low pressure environment or an inert gas atmosphere, the carbonized composite material is heated at the graphitization temperature of 2500° C. to 3000° C., such that the carbonized polyimide in the carbonized composite material is graphitized, thereby obtaining the graphite sheet. For example, the carbonized composite material is placed in a chamber with nitrogen atmosphere or argon atmosphere and heated for graphitization.

In some embodiments, the carbonization of the composite material containing artificial graphite and the graphitization of the carbonized composite material are performed in different heating chambers, but the disclosure is not limited thereto. In some other embodiments, both the carbonization and the graphitization are performed in a single heating chamber. Specifically, the temperature in the heating chamber is set at the carbonization temperature for carbonization, and then set at the graphitization temperature for graphitization.

In one embodiment, the thermal conductivity of the graphite sheet is greater than 700 W/m·K and the thermal diffusivity of the graphite sheet is greater than 4.0 cm²/sec along a planar structure of the carbon atoms arranged in hexagonal ring arrays in the sp²-hybridized state. Also, high mechanical strength and high electric conductivity are observed along the planar structure of the carbon atoms arranged in hexagonal ring arrays in the sp²-hybridized state. Therefore, the graphite sheet manufactured by the method of the disclosure is applicable to electronic devices. Specifically, the graphite sheet is able to be used to manufacture a heat dissipation component, an electrostatic discharge protection component or an electromagnetic shielding component in an electronic device.

Furthermore, the graphite sheet manufactured by the method mentioned in the above paragraphs can be smashed to obtain the artificial graphite powder for manufacturing new composite material. Thus, a graphite sheet can be recycled to manufacture new composite material and new graphite sheet by the methods of the disclosure, thereby meeting the requirements of green supply chain management.

According to the above description of the disclosure, the following specific embodiments are provided for further explanation of the properties of the composite material containing artificial graphite powder.

### First Embodiment (1st EM)

Step 1: a bulk of artificial graphite is smashed and ground to obtain an artificial graphite powder.

Step 2: 10 g of the artificial graphite powder, 200 g of zirconia beads and 50 g of DMAc are mixed together, and the artificial graphite powder is refined by ball milling dispersion to obtain a graphite dispersion solution.

Step 3: additional DMAc is added to dilute the graphite dispersion solution, and the mass fraction of the artificial graphite powder in the diluted graphite dispersion solution is 10 wt %.

Step 4: 1.05 g of diluted graphite dispersion solution (a total of 0.105 g artificial graphite powder in 1.05 g diluted graphite dispersion solution) is mixed with 101.70 g of additional DMAc. When the mixture of the diluted graphite dispersion solution and the DMAc is stirred, ODA is added to dissolve the artificial graphite powder, and then PMDA is added. The components are evenly mixed to obtain a liquid mixture containing artificial graphite powder, DMAc and polyamic acid, wherein the polyamic acid is generated by the chemical reaction of ODA and PMDA. When the viscosity of the liquid mixture reaches 10000 cps to 50000 cps (that is, 100 ps to 500 ps), stop adding PMDA and stop stirring the liquid mixture. In the liquid mixture having required viscosity, the mole ratio of PMDA to ODA in the liquid mixture is 1:1. The mass ratio of the artificial graphite powder to the total of PMDA and ODA in the liquid mixture is 0.5:100.

Step 5: the liquid mixture is spread on a substrate, and the substrate containing the liquid mixture is heated at 120° C. for 10 minutes to obtain a polyamic acid film containing artificial graphite powder. The polyamic acid film is separated from the substrate.

Next, the polyamic acid film containing artificial graphite powder is heated at 320° C. for 10 minutes to be imidized. The imidization of the polyamic acid film generates a polyimide film containing artificial graphite powder. The polyimide film containing artificial graphite powder is the composite material containing artificial graphite powder in the first embodiment. The thermal conductivity of the artificial graphite powder is greater than or equal to 1300 W/m·K.

### Second Embodiment (2nd EM)

The second embodiment is similar to the first embodiment with some difference therebetween. In the second embodiment, 2.09 g of diluted graphite dispersion solution is used in the step 4, and the diluted graphite dispersion solution is mixed with 101.29 g of DMAc. In the liquid mixture having required viscosity, the mass ratio of the artificial graphite powder to the total of PMDA and ODA in the liquid mixture is 1.0:100.

### Third Embodiment (3rd EM)

The third embodiment is similar to the first embodiment with some difference therebetween. In the third embodiment, 11.5 g of diluted graphite dispersion solution is used in the step 4, and the diluted graphite dispersion solution is mixed with 97.39 g of DMAc. In the liquid mixture having required viscosity, the mass ratio of the artificial graphite powder to the total of PMDA and ODA in the liquid mixture is 5.5:100.

### Fourth Embodiment (4th EM)

The fourth embodiment is similar to the first embodiment with some difference therebetween. In the fourth embodiment, 31.38 g of diluted graphite dispersion solution is used in the step 4, and the diluted graphite dispersion solution is mixed with 89.21 g of DMAc. In the liquid mixture having required viscosity, the mass ratio of the artificial graphite powder to the total of PMDA and ODA in the liquid mixture is 15:100.

### Fifth Embodiment (5th EM)

The fifth embodiment is similar to the first embodiment with some difference therebetween. In the fifth embodiment, 52.30 g of diluted graphite dispersion solution is used in the step 4, and the diluted graphite dispersion solution is mixed with 80.60 g of DMAc. In the liquid mixture having required viscosity, the mass ratio of the artificial graphite powder to the total of PMDA and ODA in the liquid mixture is 25:100.

### Sixth Embodiment (6th EM)

The sixth embodiment is similar to the first embodiment with some difference therebetween. In the sixth embodiment, 104.59 g of diluted graphite dispersion solution is used in the step 4, and the diluted graphite dispersion solution is mixed with 59.06 g of DMAc. In the liquid mixture having required viscosity, the mass ratio of the artificial graphite powder to the total of PMDA and ODA in the liquid mixture is 50:100.

### First Comparative Embodiment (1st CEM)

The difference between the first embodiment and the first comparative embodiment is that the polyimide film does not contain graphite powder in the first comparative embodiment.

### Second Comparative Embodiment (2nd CEM)

The difference between the first embodiment and the second comparative embodiment is that the graphite dispersion solution contains natural graphite powder. The thermal conductivity of the natural graphite powder is smaller than 300 W/m·K.

### Third Comparative Embodiment (3rd CEM)

The difference between the second embodiment and the third comparative embodiment is that the graphite dispersion solution contains natural graphite powder.

### Fourth Comparative Embodiment (4th CEM)

The difference between the third embodiment and the fourth comparative embodiment is that the graphite dispersion solution contains natural graphite powder.

### Fifth Comparative Embodiment (5th CEM)

The difference between the fifth embodiment and the fifth comparative embodiment is that the graphite dispersion solution contains natural graphite powder.

### Sixth Comparative Embodiment (6th CEM)

The difference between the sixth embodiment and the sixth comparative embodiment is that the graphite dispersion solution contains natural graphite powder.

The amount of compounds for manufacturing the polyimide film containing artificial graphite powder in the first through sixth embodiments are shown in TABLE 1.

TABLE 1

| | Mass of diluted | Mass of DMAc | | |
|---|---|---|---|---|
| | graphite dispersion | mixed with diluted | | |
| | solution used in | graphite dispersion | Mass of ODA in | Mass of PMDA in |
| | step 4 | in step 4 | the liquid mixture | the liquid mixture |
| 1st EM | 1.05 g | 101.70 g | 10.91 g | 10.01 g |
| 2nd EM | 2.09 g | 101.29 g | 10.91 g | 10.01 g |
| 3rd EM | 11.5 g | 97.39 g | 10.91 g | 10.01 g |
| 4th EM | 31.38 g | 89.21 g | 10.91 g | 10.01 g |
| 5th EM | 52.30 g | 80.60 g | 10.91 g | 10.01 g |
| 6th EM | 104.59 g | 59.06 g | 10.91 g | 10.01 g |
| 1st CEM | 0 g | 102.13 g | 10.91 g | 10.01 g |
| 2nd CEM | 1.05 g | 101.70 g | 10.91 g | 10.01 g |
| 3rd CEM | 2.09 g | 101.29 g | 10.91 g | 10.01 g |
| 4th CEM | 11.5 g | 97.39 g | 10.91 g | 10.01 g |
| 5th CEM | 52.30 g | 80.60 g | 10.91 g | 10.01 g |
| 6th CEM | 104.59 g | 59.06 g | 10.91 g | 10.01 g |

| | Mass ratio of artificial graphite powder | Mass ratio of natural graphite powder to |
|---|---|---|
| | to PMDA + ODA | PMDA + ODA |
| 1st EM | 0.5:100 | — |
| 2nd EM | 1.0:100 | — |
| 3rd EM | 5.5:100 | — |
| 4th EM | 15:100 | — |
| 5th EM | 25:100 | — |
| 6th EM | 50:100 | — |
| 1st CEM | — | — |
| 2nd CEM | — | 0.5:100 |
| 3rd CEM | — | 1.0:100 |
| 4th CEM | — | 5.5:100 |
| 5th CEM | — | 25:100 |
| 6th CEM | — | 50:100 |

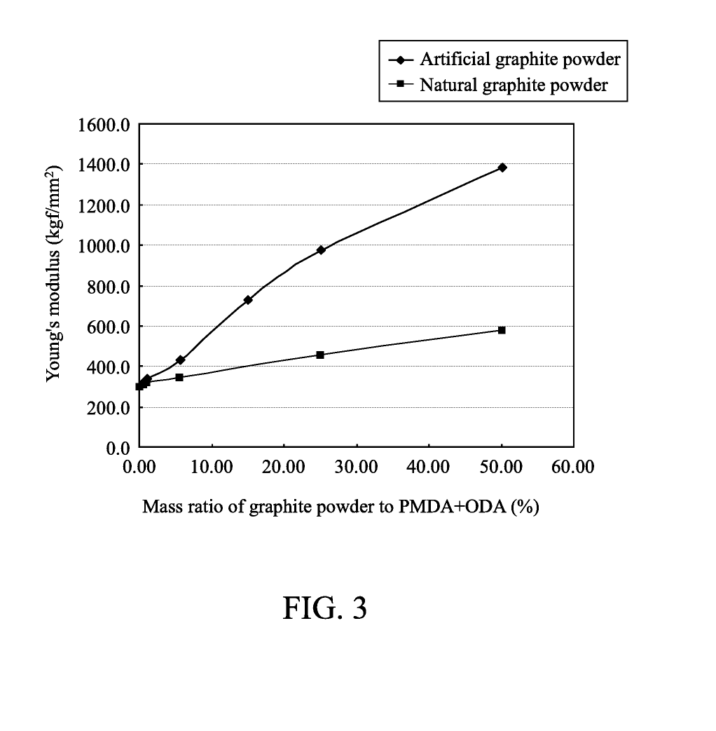

The detailed data of the first through sixth embodiments and the first through sixth comparative embodiments are shown in TABLE 2 and FIG. 3. A sample for tensile test has a thickness of 50 μm, a length of 20 cm and a width of 1 cm. The tensile testing machine is PT-VA model made by Perfect International Instruments Co., Ltd.

TABLE 2

| | | Mass ratio of |
|---|---|---|
| | Mass ratio of artificial graphite | natural graphite powder |
| | powder to PMDA + ODA | to PMDA + ODA |
| 1st EM | 0.5:100 | — |
| 2nd EM | 1.0:100 | — |
| 3rd EM | 5.5:100 | — |
| 4th EM | 15:100 | — |
| 5th EM | 25:100 | — |
| 6th EM | 50:100 | — |
| 1st CEM | — | — |
| 2nd CEM | — | 0.5:100 |
| 3rd CEM | — | 1.0:100 |
| 4th CEM | — | 5.5:100 |
| 5th CEM | — | 25:100 |
| 6th CEM | — | 50:100 |

| | Surface resistivity | Volume resistivity | Young's modulus |
|---|---|---|---|
| | Rs (Ω) | Rv (Ω · cm) | (kgf/mm²) |
| 1st EM | ≥10¹³ | 10¹³ | 318.6 |
| 2nd EM | ≥10¹³ | 10¹² | 337.4 |
| 3rd EM | 1.6 × 10¹³ | 8.9 × 10¹² | 425.9 |
| 4th EM | 4.6 × 10¹¹ | 1.8 × 10¹¹ | 727.8 |
| 5th EM | 3.06 × 10⁵ | 1.43 × 10¹⁰ | 969.2 |
| 6th EM | ≤10¹³ | 2.2 × 10⁶ | 1383.9 |
| 1st CEM | ≥10¹³ | ≥10¹³ | 301.5 |
| 2nd CEM | ≥10¹³ | ≥10¹³ | 308.4 |
| 3rd CEM | ≥10¹³ | ≥10¹³ | 319.6 |
| 4th CEM | ≥10¹³ | ≥10¹³ | 345.6 |
| 5th CEM | 6.0 × 10¹¹ | 2.1 × 10¹² | 459.5 |
| 6th CEM | 7.5 × 10³ | 7.9 × 10⁷ | 459.5 |

According to TABLE 2 and FIG. 3, the increase of the artificial graphite powder in the composite material (polyimide film) is favorable for enhancing Young's modulus of the composite material containing artificial graphite powder.

When the mass ratio of graphite powder to PMDA+ODA is 25:100, the composite material containing artificial graphite powder (5th embodiment) has smaller electric resistivity than the composite material containing natural graphite powder (5th comparative embodiment). The increase of the artificial graphite powder in the composite material is favorable for enhancing Young's modulus and reducing electric resistivity.

As shown in FIG. 3 and TABLE 2, the Young's modulus of the composite material containing artificial graphite powder in the fifth embodiment is 3.2 times higher than the Young's modulus of the composite material without graphite powder in the first comparative embodiment. The Young's modulus of the composite material containing artificial graphite powder in the fifth embodiment is 2 times higher than the Young's modulus of the composite material containing natural graphite powder in the fifth comparative embodiment.

Take the Young's modulus of the composite material in the first comparative embodiment as a benchmark, the Young's modulus of the composite material containing artificial graphite powder in the fifth embodiment is increased by 3.21 times; however, the Young's modulus of the composite material containing natural graphite powder in the fifth comparative embodiment is only increased by 1.52 times. the Young's modulus of the composite material containing artificial graphite powder in the sixth embodiment is increased by 4.59 times; however, the Young's modulus of the composite material containing natural graphite powder in the sixth comparative embodiment is only increased by 1.92 times.

The following specific embodiments are provided for further explanation of the influence of imidization temperature on both the Young's modulus and the tensile strength of the composite material containing artificial graphite powder.

### Seventh Embodiment (7th EM)

The seventh embodiment is similar to the fourth embodiment with some difference therebetween. In the seventh embodiment, the polyamic acid film containing artificial graphite powder is heated at 150° C. for 30 minutes to be imidized. The imidization of the polyamic acid film generates a polyimide film containing artificial graphite powder.

### Eighth Embodiment (8th EM)

The eighth embodiment is similar to the fourth embodiment with some difference therebetween. In the eighth embodiment, the polyamic acid film containing artificial graphite powder is heated at 200° C. for 30 minutes to be imidized. The imidization of the polyamic acid film generates a polyimide film containing artificial graphite powder.

### Ninth Embodiment (9th EM)

The ninth embodiment is similar to the fourth embodiment with some difference therebetween. In the ninth embodiment, the polyamic acid film containing artificial graphite powder is heated at 250° C. for 30 minutes to be imidized. The imidization of the polyamic acid film generates a polyimide film containing artificial graphite powder.

### Tenth Embodiment (10th EM)

The tenth embodiment is similar to the fourth embodiment with some difference therebetween. In the tenth embodiment, the polyamic acid film containing artificial graphite powder is heated at 300° C. for 30 minutes to be imidized. The imidization of the polyamic acid film generates a polyimide film containing artificial graphite powder.

### Eleventh Embodiment (11th EM)

The eleventh embodiment is similar to the fourth embodiment with some difference therebetween. In the eleventh embodiment, the polyamic acid film containing artificial graphite powder is heated at 350° C. for 30 minutes to be imidized. The imidization of the polyamic acid film generates a polyimide film containing artificial graphite powder.

### Seventh Comparative Embodiment (7th CEM)

The difference between the seventh embodiment and the seventh comparative embodiment is that the polyimide film does not contain graphite powder in the seventh comparative embodiment.

### Eighth Comparative Embodiment (8th CEM)

The difference between the eighth embodiment and the eighth comparative embodiment is that the polyimide film does not contain graphite powder in the eighth comparative embodiment.

### Ninth Comparative Embodiment (9th CEM)

The difference between the ninth embodiment and the ninth comparative embodiment is that the polyimide film does not contain graphite powder in the ninth comparative embodiment.

### Tenth Comparative Embodiment (10th CEM)

The difference between the tenth embodiment and the tenth comparative embodiment is that the polyimide film does not contain graphite powder in the tenth comparative embodiment.

### Eleventh Comparative Embodiment (11th CEM)

The difference between the eleventh embodiment and the eleventh comparative embodiment is that the polyimide film does not contain graphite powder in the eleventh comparative embodiment.

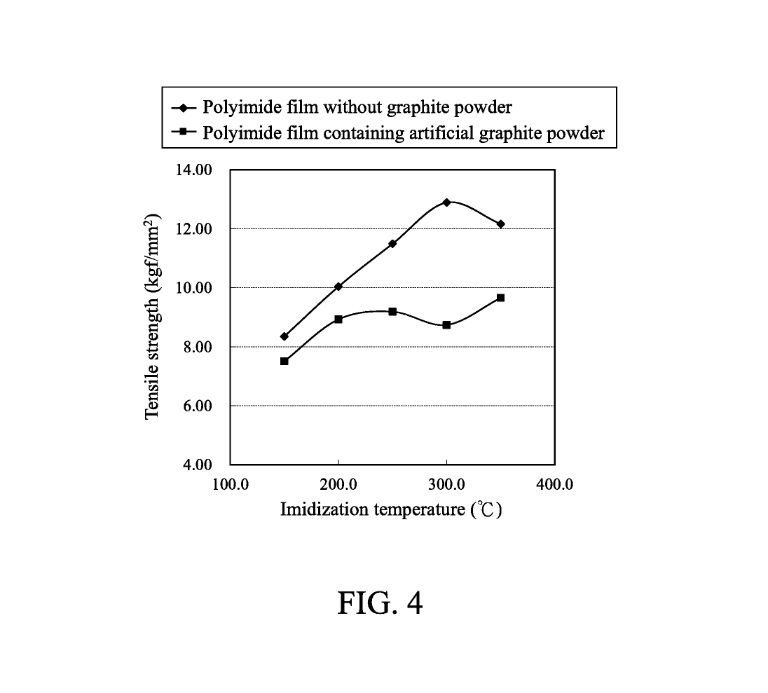

The detailed data of the seventh through eleventh embodiments and the seventh through eleventh comparative embodiments are shown in TABLE 3 and FIG. 4. A sample for tensile test has a thickness of 50 μm, a length of 20 cm and a width of 1 cm. The tensile testing machine is PT-VA model made by Perfect International Instruments Co., Ltd.

TABLE 3

| | Mass ratio of | | | |
|---|---|---|---|---|
| | artificial graphite | Imidization | Tensile | Young's |
| | powder to | temperature | strength | modulus |
| | PMDA + ODA | (° C.) | (kgf/mm²) | (kgf/mm²) |
| 7th EM | 15:100 | 150 | 7.51 | 639.03 |
| 8th EM | 15:100 | 200 | 8.93 | 683.86 |
| 9th EM | 15:100 | 250 | 9.19 | 636.93 |
| 10th EM | 15:100 | 300 | 8.74 | 561.71 |
| 11th EM | 15:100 | 350 | 9.66 | 644.03 |
| 7th CEM | — | 150 | 8.35 | 316.22 |
| 8th CEM | — | 200 | 10.04 | 314.65 |
| 9th CEM | — | 250 | 11.49 | 324.04 |
| 10th CEM | — | 300 | 12.89 | 308.97 |
| 11th CEM | — | 350 | 12.16 | 307.95 |

As shown in TABLE 3 and FIG. 4, when the imidization temperature is higher than 150° C., the polyimide films containing artificial graphite powder in the seventh through eleventh embodiments have higher Young's modulus, which represents excellent mechanical properties and reliability.

In the seventh through eleventh embodiments, with the rise of imidization temperature, the tensile strength of the polyimide film containing artificial graphite powder gradually increases in the temperature range lower than 200° C., and then slows down in the temperature range higher than 200° C. The higher the ratio of polyimide to polyamic acid in the composite material is, the higher the tensile strength of the composite material is. Thus, slowing rise of the tensile strength in the temperature range higher than 200° C. indicates that most of the polyamic acid is completely imidized to become polyimide. According to FIG. 4, the imidization of the polyamic acid film containing artificial graphite powder is completely accomplished at a lower imidization temperature, thereby obtaining the polyimide film containing artificial graphite powder (the composite material containing artificial graphite powder). In contrast, in the seventh through eleventh comparative embodiments, with the rise of imidization temperature, the tensile strength of the polyimide film without graphite powder gradually increases in the temperature range lower than 300° C., and then slows down in the temperature range higher than 300° C.; thus, it is indicated that most of the polyamic acid is completely imidized to become polyimide when the temperature is higher than 300° C. Accordingly, the composite material containing artificial graphite powder is able to be completely imidized at lower imidization temperature, such that it is favorable for reducing manufacturing cost as well as reducing carbon emissions.

According to the disclosure, the composite material contains evenly distributed artificial graphite powder, and the artificial graphite powder is favorable for improving the mechanical properties of the composite material and increasing the reliability of the composite material.

Furthermore, due to the distribution of the artificial graphite powder in the composite material, small surface resistivity of the composite material containing artificial graphite is favorable for reducing electrostatic charge. The electrons on the surface of the composite material are easily removed so as to prevent electrostatic discharge. Thus, the composite material containing artificial graphite powder is applicable to anti-static, ESD protection and EMI shielding. Since the composite material containing artificial graphite is able to be used as a film for anti-static, EMI reduction or electric conduction, it is widely applicable to optoelectronic products and communication products.

Moreover, the distribution of the artificial graphite powder in the composite material is favorable for preventing pollution caused by non-sloughing of a film or paint on the surface of the composite material.

In addition, a substandard composite material containing artificial graphite is recyclable and reusable to manufacture artificial graphite sheet, and the artificial graphite sheet is taken as the graphite sheet of the disclosure to reduce manufacturing cost. Therefore, composite material containing artificial graphite of the disclosure is potential for industrial applications.

According to the disclosure, the recycled composite material containing artificial graphite is able to be reprocessed to manufacture a graphite sheet by the method of the disclosure. The graphite sheet is able to be smashed to obtain the artificial graphite powder for manufacturing new composite material. In other words, the artificial graphite powder is obtained by reprocessing the composite material containing artificial graphite taken from a discarded electronic device, and the artificial graphite powder is used to manufacture a new composite material which is applicable to new electronic devices. Therefore, the composite material containing artificial graphite, the graphite sheet and the method of manufacturing the same meet the requirement of green supply chain management.

According to the disclosure, the composite material containing artificial graphite enjoys the advantages of low manufacturing cost and less carbon emissions able to be imidized at lower imidization temperature, thereby meeting the requirement of environmental protection.

The foregoing description, for the purpose of explanation, has been described with reference to specific embodiments; however, the embodiments were chosen and described in order to explain the principles of the disclosure and its practical applications, to thereby enable others skilled in the art to utilize the disclosure and various embodiments with various modifications as are suited to the particular use being contemplated. The embodiments depicted above and the appended drawings are exemplary and are not intended to be exhaustive or to limit the scope of the disclosure to the precise forms disclosed. Modifications and variations are possible in view of the above teachings.

What is claimed is:

1. A method of manufacturing a composite material containing artificial graphite, comprising:
mixing an artificial graphite powder and a first solvent together to obtain a graphite dispersion solution, wherein a particle size of the graphite powder is less than 50 μm;
mixing the graphite dispersion solution and a polyamic acid solution together to obtain a liquid mixture;
heating the liquid mixture to obtain a polyamic acid film containing the artificial graphite powder; and
performing imidization of the polyamic acid film containing the artificial graphite powder to obtain the composite material containing artificial graphite.

2. The method according to claim 1, wherein in step of mixing the graphite dispersion solution and the polyamic acid solution together, the graphite dispersion solution, a second solvent, a diamine and a dianhydride are mixed together to obtain the liquid mixture.

3. The method according to claim 2, wherein a mole ratio of the diamine to the dianhydride in the liquid mixture is from 0.98:1 to 1.05:1.

4. The method according to claim 1, wherein the polyamic acid solution is obtained by mixing a second solvent, a diamine and a dianhydride together, and a mass ratio of the artificial graphite powder to a total of the diamine and the dianhydride is from 0.5:100 to 50:100.

5. The method according to claim 1, further comprising:
grinding a bulk of artificial graphite to obtain the artificial graphite powder.

6. The method according to claim 1, wherein the artificial graphite powder and the first solvent are mixed together by ball milling dispersion.

7. The method according to claim 1, wherein a viscosity of the liquid mixture is from 10000 cps to 50000 cps.

8. The method according to claim 1, wherein a mass fraction of the artificial graphite powder in the composite material containing artificial graphite is from 0.5 wt % to 40 wt %.

9. The method according to claim 1, wherein the artificial graphite powder is obtained by graphitizing a polyimide film.

10. The method according to claim 1, wherein the artificial graphite powder is obtained by smashing a heat dissipation component, an electrostatic discharge protection component or an electromagnetic shielding component in an electronic device.

11. The method according to claim 1, wherein in step of performing imidization of the polyamic acid film containing the artificial graphite powder, the polyamic acid film containing the artificial graphite powder is heated at a temperature of 150° C. to 250° C. for 25 minutes to 35 minutes to obtain the composite material containing artificial graphite.

12. The method according to claim 1, wherein a mass fraction of the artificial graphite powder in the graphite dispersion solution is less than or equal to 10 wt %.

13. The method according to claim 1, wherein a thermal conductivity of the artificial graphite powder is greater than or equal to 700 W/m·K.

14. A composite material containing artificial graphite, comprising:
a polyimide base material; and
an artificial graphite powder distributed in the polyimide base material, wherein a particle size of the graphite powder is less than 50 μm.

15. The composite material containing artificial graphite according to claim 14, wherein the artificial graphite powder is obtained by graphitizing a polyimide film.

16. The composite material containing artificial graphite according to claim 14, wherein the artificial graphite powder is obtained by smashing a heat dissipation component, an electrostatic discharge protection component or an electromagnetic shielding component in an electronic device.

17. The composite material containing artificial graphite according to claim 14, wherein a mass fraction of the artificial graphite powder in the composite material containing artificial graphite is from 0.5 wt % to 40 wt %.

18. The composite material containing artificial graphite according to claim 14, wherein a thermal conductivity of the artificial graphite powder is greater than or equal to 700 W/m·K.

19. A method of manufacturing a graphite sheet, comprising:
providing a composite material containing artificial graphite manufactured by the method according to claim 1; and
heating the composite material containing artificial graphite to obtain the graphite sheet.

20. The method according to claim 19, wherein a thermal conductivity of the graphite sheet is greater than 700 W/m·K.

21. The method according to claim 19, wherein a thermal diffusivity of the graphite sheet is greater than 4.0 cm²/sec.

22. The method according to claim 19, wherein step of heating the composite material containing artificial graphite comprises:
carbonizing the composite material containing artificial graphite at a carbonization temperature to obtain a carbonized composite material; and
graphitizing the carbonized composite material at a graphitization temperature to obtain the graphite sheet, wherein the graphitization temperature is higher than the carbonization temperature.

23. The method according to claim 22, wherein the carbonization temperature is from 900° C. to 1500° C., and the graphitization temperature is from 2500° C. to 3000° C.

24. A method of manufacturing a composite material containing artificial graphite, comprising:
mixing an artificial graphite powder and a first solvent together to obtain a graphite dispersion solution, wherein the artificial graphite powder is obtained by graphitizing a substandard polyimide film;
mixing the graphite dispersion solution and a polyamic acid solution together to obtain a liquid mixture;
heating the liquid mixture to obtain a polyamic acid film containing the artificial graphite powder; and
performing imidization of the polyamic acid film containing the artificial graphite powder to obtain the composite material containing artificial graphite.

25. The method according to claim 24, wherein the substandard polyimide film is unavailable to be as an element in an electronic device.

26. The method according to claim 24, wherein the substandard polyimide film is a film scrap from cut polyimide film.

27. The method according to claim 24, wherein the substandard polyimide film is obtained from a discarded electronic device.
